(19) United States
(12) Patent Application Publication
(10) Pub. No.: US 2015/0135569 A1
(43) Pub. Date: May 21, 2015

(54) FLASHING AIR DANCER

(71) Applicant: Torero Specialty Products LLC, Monrovia, CA (US)

(72) Inventor: Nick KUSANOVICH, San Francisco, CA (US)

(73) Assignee: Torero Specialty Products LLC, Monrovia, CA (US)

(21) Appl. No.: 14/084,446

(22) Filed: Nov. 19, 2013

(51) Int. Cl. G09F 19/08; A63H 3/06

(52) U.S. Cl. CPC G09F 19/08; A63H 3/06; G09F 2019/086
USPC 40/412; 156/60; 29/428

(57) ABSTRACT

A flashing air dancer can be provided via an air dancer including flashing appendages that flash by reflection, attached to hollow portions of the air dancer. The hollow portions can include a first hollow portion having two open ends. A first open end can receive a gas from a gas delivery source, such as a blower, for inflating the air dancer. The gas can exit via a second open end. Flashing appendages can be attached via stitching, sewing, adhesion, or fastening. Flashing appendages can be comprised of material having persistent high reflectivity. Flashing appendages can be comprised of material with a coating having persistent high reflectivity. Flashing appendages may have the form of flashing strips. Flashing strips may be two-ply or thicker in layers of material, and different layers of the flashing strips may include different kinds of layer material.

### FIELD

This relates generally to air dancers and, more specifically, to flashing air dancers. A flashing air dancer may provide a flashing appearance via appendages, such as strips, that flash by reflection.

### BACKGROUND

Inflatable objects have been used for a variety of purposes, such as catching attention. A cluster of small balloons is a common example for decorative purposes. Giant inflatable objects in the shape of animal characters have been used as advertising products.

Another example is an air dancer, an inflatable device commonly characterized by a tubular body with a first open end that can be attached to a blower. At the first open end, the blower can inflate the tubular body with gas, e.g., air. The air can exit the tubular body at another open end. As air from the blower flows through the tubular body, the air dancer can move. Air dancers with multiple tubular portions can resemble humans with tube arms and/or legs that move with lifelike, unpredictable, dynamic, dancing-like motion. For practical applications, air dancers have been used for advertising and for providing entertainment value at social events, such as parties, weddings, and school events. Exemplary air dancers and related teachings are disclosed by U.S. Pat. No. 6,186,857 to Gazit et al., the entirety of which is incorporated by reference herein.

### BRIEF SUMMARY

A flashing air dancer can be provided via an air dancer including one or more flashing appendages that flash by reflection, attached to one or more hollow portions of the air dancer. The one or more hollow portions can include a first hollow portion having two open ends. A first open end can receive a gas from a gas delivery source for inflating the air dancer. The gas can exit via a second open end. The gas delivery source may comprise a blower. The flashing appendages can be attached via stitching, sewing, adhesion, or fastening.

The flashing appendages can be comprised of material having persistent high reflectivity. The flashing appendages can be comprised of material with a coating having persistent high reflectivity.

The flashing appendages may have the form of flashing strips. The flashing strips may be two-ply or thicker in layers of material, and different layers of the flashing strips may include different kinds of layer material.

### BRIEF DESCRIPTION OF THE DRAWINGS

FIG. 1A shows example apparatus 100.

FIG. 1B illustrates air dancer 110 in a bending position.

FIG. 2 shows example apparatus 200.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

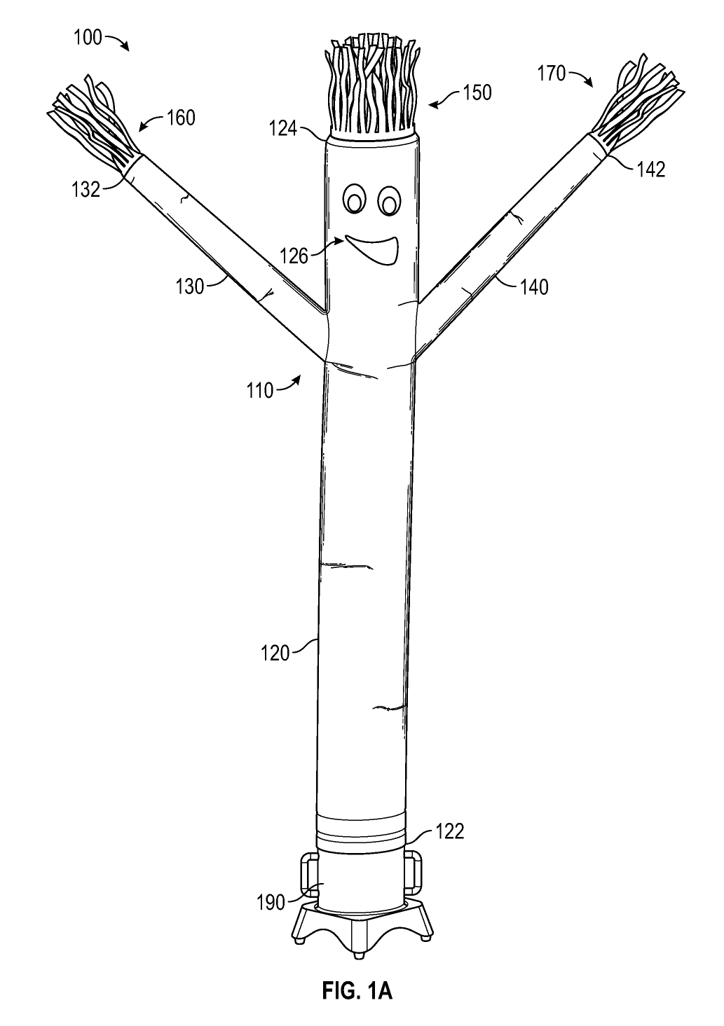

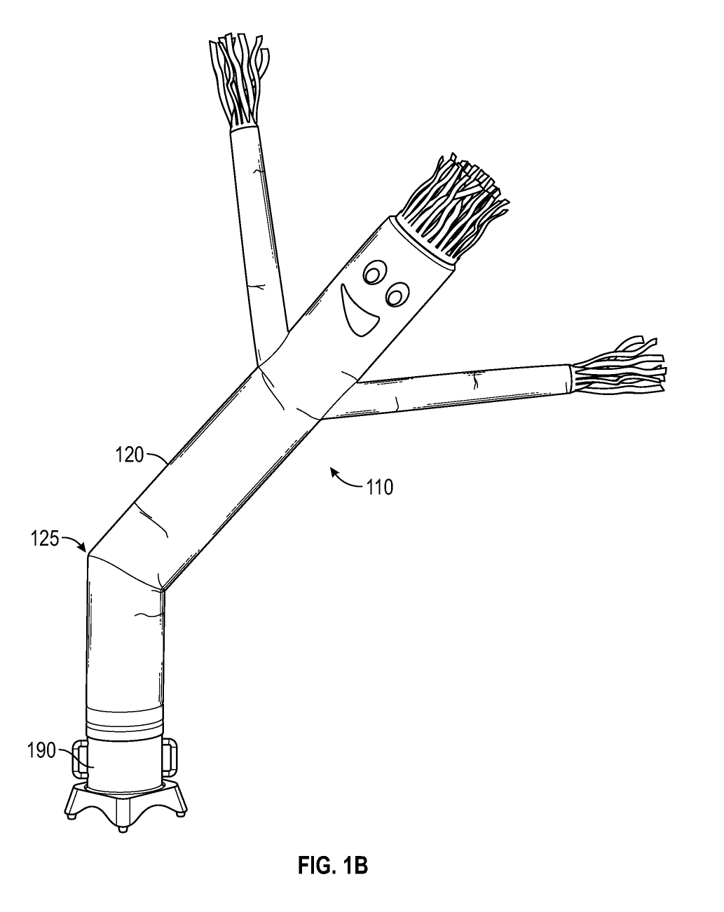

FIG. 1A shows example apparatus 100. Apparatus 100 includes air dancer 110 and blower 190. Air dancer 110 can resemble a human with a hollow central portion 120 and two hollow, tubular, arm-like portions 130 and 140. Central portion 120 has a first central open end 122 through which blower 190 can inflate air dancer 110 with gas, e.g., air. Central portion 120 also has a second central open end 124 through which air can exit air dancer 110. Left portion 130 and right portion 140 respectively have left open end 132 and right open end 142. Air can also flow from central portion 120 into left and right portions 130 and 140 and exit air dancer 110 through left open end 132 and right open end 142. Central portion 120 may also have image 126, like a human face, on its exterior.

Air dancer 110 can have additional aspects that contribute to a more human-like appearance, e.g., the use of strips. The form of such strips is not limited to flat, rectangular shapes but can encompass many other forms, such as appendages that are square, arc-shaped, rounded, circular, elliptical, diamond, polygonal, twisted, curved, convex, concave, etc. At second central open end 124, central strips 150 can resemble hair on a head. Left strips 160 and right strips 170 can resemble fingers at left open end 132 and right open end 142, respectively. One or more strips among strips 150, 160, and 170 may be flashing by reflection of incident electromagnetic radiation, such as visible light, creating a visual effect for effectively catching attention.

As blower 190 blows air into and through central portion 120, left portion 130 and right portion 140, air dancer 110 can move with lifelike, unpredictable, dynamic, dancing-like motion. Strips 150, 160, and 170 may dynamically move as air is blown out of second central open end 124, left open end 132, and right open end 142. During such motion, flashing strips among strips 150, 160, and 170 can create a highly noticeable visual phenomenon of dynamic motion with flashing, glittering, or shimmering effects.

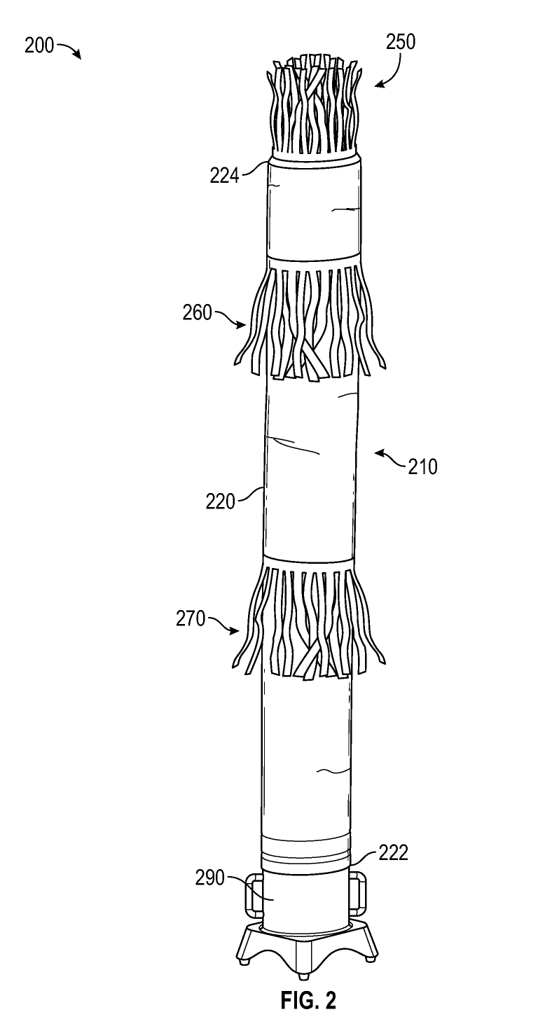

FIG. 1B illustrates air dancer 110 in a bending position. Together, FIGS. 1 and 2 indicate movement of air dancer 110. FIG. 1A shows air dancer 110 in a fully extended position. FIG. 1B shows air dancer 110 with a bend 210 in central portion 120. Bend 210 and the dancing-like motion of air dancer 110 may be the product of multiple factors, such as air blown by blower 190, gravity, and wind effects. For example, air from blower 190 can exert upward forces on parts of air dancer 110, gravity can exert downward force on air dancer 110, and wind effects can exert forces on air dancer 110 in multiple directions.

Air dancer 110 can be created from a variety of materials. Exemplary materials for portions 120, 130, and 140 may include, without limitation, nylon, ripstop fabrics, oxford cloth, canvas, and blends of such materials. Air dancer materials may be generally impermeable to gas from blower 190. For other exemplary non-limiting characteristics, air dancer materials may be high-strength, lightweight, non-rip, flexible, or durable.

Strips 150, 160, and 170 can be made from the same above kinds of materials for portions 120, 130, and 140 or alternatively made from different kinds of materials. Strips 150, 160, and 170 may be joined to portions 120, 130, and 140, respectively, in various ways. In one example, a strip and a portion may be uniformly produced from the same sheet of material. In other examples, a strip may be attached to a portion by stitching, sewing, adhesion, fastening, or other ways of attachment.

For flashing strips among strips 150, 160, and 170, the construction of a flashing strip can be significant. A flashing strip is strong and has persistent high reflectivity so as to be flashing. Located respectively at ends 124, 132, and 142, strips 150, 160, and 170 may whip and undulate strongly, or even violently. Thus, the base material of a flashing strip must be strong so as not to disintegrate or break into pieces during minimal air dancer operation. When joined to a portion of air dancer 110 by attachment, the flashing strip material should be strong enough to maintain the attachment during air dancer operation. For a contrasting example, 0.9 mm polyester tape used as bird scare flash tape may be reflective, but too weak to function as the flashing strips of air dancer 110. By intentional design, such polyester tape needs to be light to flutter in ambient wind. The light construction of such polyester tape also contributes to its relatively low cost. When attached to an air dancer by fasteners (e.g., staples), such polyester tape disintegrates after minimal air dancer operation. Also, such polyester tape attached by fasteners breaks into pieces and falls off an air dancer.

In addition to strength, a flashing strip should have high reflectivity that persists, enduring the wear from strong, whipping, undulating motions of air dancer movements. For a contrasting example, metallic paints, such as silver-colored or gold-colored paint, may have some reflectivity but not high enough reflectivity so as to be flashing. Also, such a metallic paint (and its reflectivity) on strips 150, 160, and 170 would fade due to the wear from repeatedly whipping and undulating during even minimal air dancer operation.

Material that is suitable for flashing strips among strips 150, 160, and 170 may include flashing cloth or fabric. The flashing material may be different from the material(s) of portions 120, 130, and 140 of air dancer 110. The flashing material may be different from the material(s) of non-flashing strips of strips 150, 160, and 170. The strength of a flashing strip may be provided by the woven nature of the flashing cloth or fabric. On one hand, the flashing cloth or fabric may be strong enough to endure the wear of air dancer operation, e.g., not disintegrate or break apart during air dancer operation. On the other hand, the flashing cloth or fabric may be light enough so that a flashing strip can flutter or undulate during air dancer operation, e.g., not weigh down portions 120, 130, and 140. The flashing strip material can be one-ply, two-ply, or thicker.

The flashing quality of a flashing strip may be provided by persistent high reflectivity of the flashing cloth or fabric itself. Alternatively, a flashing strip may be created from a strong, durable material with a coating that has high reflectivity that persists, enduring the wear of air dancer operation.

A flashing strip can be uniform or non-uniform in its reflective surfacing. One side of the flashing strip material may be highly reflective, e.g., having a silver or iridescent shine. Another side may be equally or less reflective, e.g., having an equal or duller shine or a different color, such as gold or red.

A flashing strip may be one-ply, two-ply, or thicker in layers of material. Different layers may include the same or different kinds of layer material.

One example of a flashing strip may be a strip of 300-denier nylon having a silver-colored coating. The thickness may be around 0.2 mm. The weight may be around 260 g/m². The longitude (kg/cm) may be 27 kg/cm. The latitude may be 18 kg/cm. One side of the example flashing strip can have a persistent and highly reflective silver shine. Another side can have a gold shine. The example flashing strip can be attached to air dancer 110 by stitching at one end. Another end of the example flashing strip can be free to flutter or undulate or whip during air dancer operation.

Blower 190 may be any gas delivery source or device that can inflate air dancer 110 with gas, e.g., air. As blower 190 blows air into first central open end 122, air dancer 110 can move with lifelike, unpredictable, dynamic, dancing-like motion. First central open end 122 can attach directly to blower 190 through any suitable attachment, such as fixed fasteners, Velcro, buttons, rings, etc. Alternatively, first central open end 122 can be separated from blower 190 by an intervening space, but blower 190 can still blow air into first central open end 122. Blower 190 may be noisy or generate low noise. Blower 190 may be powered by any suitable power source, e.g., a power cord to a building's electrical outlet or to a portable generator. An exemplary blower may operate on 110 v, 220 v, or other voltages.

Air dancer 110 is illustrated in FIGS. 1 and 2 as having a shape resembling a human with two arms. Variants include shapes with parts resembling two legs. Other variants include alternative shapes resembling objects such as trees and flames.

FIG. 2 shows example apparatus 200 with air dancer 210 having an exemplary alternative shape. Apparatus 200 includes air dancer 210 and blower 290. Air dancer 210 can resemble a tube with hollow central portion 220, upper strips 250, middle strips 260, and lower strips 270. Central portion 220 has a first central open end 222 attached to blower 290 that can inflate air dancer 210 with gas, e.g., air. Central portion 220 also has a second central open end 224 through which air can exit air dancer 210. One or more strips among strips 250, 260, and 270 may be flashing, creating a visual effect for effectively catching attention.

As blower 290 blows air into and through central portion 220, air dancer 210 can move with lifelike, unpredictable, dynamic, dancing-like motion. Strips 250, 260, and 270 may dynamically move as air is blown out of second central open end 224. During such motion, flashing strips among strips 250, 260, and 270 can create a highly noticeable visual phenomenon of dynamic motion with flashing, glittering, or shimmering effects.

Upper strips 250 may be joined to central portion 220 in FIG. 2 through the same teachings disclosed above for joining central strips 150 to central portion 120 in FIG. 1. Middle strips 260 and lower strips 270 may be joined to central portion 220 in FIG. 2 by stitching, sewing, adhesion, fastening, or other ways of attachment.

The above discussion regarding materials for air dancer 110 and flashing strips in FIGS. 1A and 1B may also apply to materials for air dancer 210 and flashing strips in FIG. 2. The above discussion regarding details about blower 190 in FIGS. 1A and 1B may also apply to details about blower 290 in FIG. 2.

To facilitate proper understanding and appreciation of the advances and developments provided by this disclosure, the perspective of the air dancer industry and an air dancer designer is discussed below. With this perspective, it becomes clearer how the above teachings demonstrate innovations over significant barriers in this field of art.

In the air dancer industry, air dancer design has developed under a prevailing paradigm of catching human attention at minimal cost. Thus, for human attention, an air dancer designer generally develops an air dancer to have the basic, dynamic motion that provides the visual effect that attract human notice and is recognizable as characteristic of air dancers.

For cost considerations, there is strong motivation in the industry to keep costs low. This drive for low cost has directed air dancer design to employ the most inexpensive methods of manufacture. For instance, an air dancer is generally made from a single, uniform material for multiple reasons. A single, uniform material has uniform performance throughout an air dancer. Also, manipulating a single kind of material is simpler to coordinate and manage than working with multiple kinds of material.

Modifications to the visual appearance of air dancers have been limited to the most basic and inexpensive techniques, such as decorating the exterior appearance through the use of different colors, texts, and images. Even with such decorations, air dancer materials have generally provided the same kind of visual appearance. For instance, nylon, ripstop fabrics, oxford cloth, canvas, and blends of such materials all generally have an inherent visual appearance with a matte-like texture. Even when decorated with different colors, texts, and images, such materials still have a visual appearance with a matte-like texture. Moreover, even if different parts of an air dancer were made a plurality of such materials, which would increase costs, the air dancer would still have a visual appearance with a matte-like texture.

In contrast, the above teachings disclose a wholly different kind of visual appearance—a flashing appearance. Additionally, the visual effect is not just a static, uniformly flashing appearance, but a dynamic visual effect with a varying flashing appearance. For instance, flashing strips need not be placed over the entirety of an air dancer, but may be located at specific locations so that there is a visual appearance of randomly directed and randomly located flashes of reflected light. The use of an air dancer with a flashing appearance is not trivial in the field of air dancer design, as exemplified by multiple barriers.

For one exemplary barrier, there is the prevailing design paradigm to focus on human attention. Air dancers are often designed to be employed as signage along roads for motorists. Although a flashing appearance may catch human attention, random flashing may be considered to be too distracting and potentially unsafe for common locations for air dancers, such as roadsides.

There is a known example of using air dancers for deterring birds called Air Crow. Even so, the design of Air Crow air dancers only indicate the same kind of above simple modifications directed to human attention—decorating an air dancer with different colors, texts, and images. Stated differently, even when used to catch non-human attention, Air Crow air dancers still have a visual appearance based on the prevailing design paradigm that focuses on human attention. In other words, an Air Crow air dancer reflects a conventional air dancer design, just employed in an environment with birds.

For another exemplary barrier, there are constraints in manufacturing. In order to create flashing strips for air dancers, as above, an air dancer designer cannot simply synthesize a suitable candidate for flashing strip material from imagination. Rather, proper engineering is required. To provide a strip that flashes, an air dancer designer may exclude off-the-shelf paints and conventional cloths and fabrics. To provide a strip that flutters, an air dancer designer may exclude solid, heavy, metallic objects. To provide a strip that endures the wear of air dancer motion, an air dancer designer may exclude flash tape. In other words, an air dancer designer would need to conduct requisite engineering to identify or develop a flashing strip material suitable for air dancer operation.

Some example applications for the apparatuses provided by this disclosure include advertising and providing entertainment value at social events. Another example application includes providing a solution to the problem of birds and other pests consuming agricultural produce.

Several bird/pest deterrents exist, but the market lacks an economical solution that is effective. As a mannequin in the shape of a human, a traditional scarecrow appears as if a person is actually policing the field to deter birds. Although a scarecrow may be effective for a very short period of time, birds quickly become fearless of scarecrows due to the lack of movement.

Netting can be either suspended to create a canopy or draped over plants and trees to create a barrier between the produce and birds. Netting is extremely expensive and must be removed during harvest, when produce is most desired. Birds are still able to access the produce that lies against the netting, and smaller birds can pass though the netting.

Repellant spray can apply chemicals to produce multiple times throughout the harvesting process. The taste is supposed to deter birds. Chemicals, however, may also deter human consumers.

Propane cannons can create loud noises to scare away birds. Set to a timer on regular intervals, a propane cannon can operate at 125 decibels and fire over 350 blasts per day. Such cannons are very controversial within communities as major noise pollution.

Reflective flash tape can be placed in small strips on rows of various produce. The reflective flash tape flutters in the wind and reflection of light can catch the eyes of birds for the purpose of deterring them away. Without wind, however, the reflective flash tape may not flutter. Even with wind, the amount of fluttering motion may be highly limited, and birds may become used to the limited motion.

In contrast, the apparatuses provided by this disclosure can provide a solution that avoids all the above deficiencies of lack of movement, expensive netting, chemicals, major noise pollution, and highly limited motion.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

What is claimed is:

1. An apparatus comprising:
an air dancer including:
one or more hollow portions including a first hollow portion including:
a first open end for receiving a gas from a gas delivery source for inflating the air dancer;
a second open end for exiting the gas;
one or more flashing appendages that flash by reflection attached to one of said one or more hollow portions.

2. The apparatus of claim 1, wherein the one or more flashing appendages is comprised of material having persistent high reflectivity.

3. The apparatus of claim 1, wherein the one or more flashing appendages is comprised of material with a coating having persistent high reflectivity.

4. The apparatus of claim 1, wherein the one or more flashing appendages has the form of one or more flashing strips.

5. The apparatus of claim 4, wherein the one or more flashing strips is two-ply or thicker in layers of material, wherein different layers of the one or more flashing strips include different kinds of layer material.

6. The apparatus of claim 1, wherein the gas delivery source comprises a blower.

7. A method for use with an air dancer including one or more hollow portions, the method comprising:
attaching one or more flashing appendages that flash by reflection to one of said one or more hollow portions of the air dancer,
wherein the air dancer includes a first hollow portion among said one or more hollow portions, the first hollow portion including:
a first open end for receiving a gas from a gas delivery source for inflating the air dancer;
a second open end for exiting the gas.

8. The method of claim 7, wherein the one or more flashing appendages is comprised of material having persistent high reflectivity.

9. The method of claim 7, wherein the one or more flashing appendages is comprised of material with a coating having persistent high reflectivity.

10. The method of claim 7, wherein the one or more flashing appendages has the form of one or more flashing strips.

11. The method of claim 10, wherein the one or more flashing strips is two-ply or thicker in layers of material, wherein different layers of the one or more flashing strips include different kinds of layer material

12. The method of claim 7, wherein said attaching including stitching, sewing, adhesion, or fastening.

13. A system comprising:
a gas delivery source;
an air dancer including:
one or more hollow portions including a first hollow portion including:
a first open end for receiving a gas from the gas delivery source for inflating the air dancer;
a second open end for exiting the gas;
one or more flashing appendages that flash by reflection attached to one of said one or more hollow portions.

14. The system of claim 13, wherein the one or more flashing appendages is comprised of material having persistent high reflectivity.

15. The system of claim 13, wherein the one or more flashing appendages is comprised of material with a coating having persistent high reflectivity.

16. The system of claim 13, wherein the one or more flashing appendages has the form of one or more flashing strips.

17. The system of claim 16, wherein the one or more flashing strips is two-ply or thicker in layers of material, wherein different layers of the one or more flashing strips include different kinds of layer material.

18. The system of claim 13, wherein the gas delivery source comprises a blower.
